(19) United States
(12) Patent Application Publication
(10) Pub. No.: US 2023/0304551 A1
(43) Pub. Date: Sep. 28, 2023

(54) Electromagnetic Braking Device Configured to Brake a Rotary Shaft and Mobility System Comprising the Device and the Rotary Shaft

(71) Applicant: Warner Electric Europe S.A.S., Saint Barthelemy D'Anjou (FR)

(72) Inventors: Eric Volant, Denee (FR); Anais Farrugia, Angers (FR); Kévin Rousseau, Briollay (FR); Eric Gandon, Monteuil Juigne (FR)

(21) Appl. No.: 18/191,082

(22) Filed: Mar. 28, 2023

(30) Foreign Application Priority Data
Mar. 28, 2022 (FR) 2202770
Nov. 28, 2022 (FR) 2212399

(51) Int. Cl. F16D 65/18

(52) U.S. Cl. CPC F16D 65/186; F16D 2121/20

(57) ABSTRACT

An electromagnetic braking device for braking a rotary shaft includes a friction disk mounted to the shaft and movable in translation and rotation, an outer part, and an intermediate part movable in translation between the friction disk and the outer part. At least one of the outer and intermediate parts is magnetic. At least one electromagnetic actuating member and at least one mechanical actuating member are housed in the other of the outer and intermediate parts. The intermediate part moves in a first direction toward the friction disk under the action of the mechanical actuating member and in a second direction toward the outer part under the action of the electromagnetic actuating member. A plurality of independent magnetic sheets move in translation between the intermediate and outer parts under the action of the mechanical actuating member and/or electromagnetic actuating member.

### CROSS-REFERENCE TO RELATED APPLICATIONS

This patent application claims, under 35 U.S.C. § 119, the benefit and priority of French Patent Application No. 2202770 filed on Mar. 28, 2022 and French Patent Application No. 2212399 filed on Nov. 28, 2022, the entire disclosures of which are incorporated by reference herein.

### BACKGROUND OF THE INVENTION

### a. Field of the Invention

The present invention relates to an electromagnetic braking device for blocking at least one rotary shaft.

Such braking devices are in particular implemented to block the rotary shaft in elevators, forklift trucks, and more generally in any type of device requiring prolonged secure stops.

The invention also relates to a mobility system, of the elevator or forklift type, comprising such a device mounted on such a rotary shaft.

### b. Background Art

Mobility systems of the elevator or forklift type are known, which are provided with a rotary shaft that must be able to be tightened and blocked in rotation for a determined period, in particular during prolonged secure stops.

To do this, these systems are also provided with an electromagnetic braking device, or electromagnetic brake, which comprises a body, a friction disk which is mounted so as to be movable in translation and in rotation, the friction disk being configured to be secured to the rotary shaft, and an armature movable in a first direction under the action of an electromagnetic force generated by an electric coil housed in the body and in a second direction under the action of a force exerted by one or more compression springs also partially housed in the body.

Often, the armature is formed of a solid and magnetizable metal block that is biased directly by the springs.

Also known, for example from Japanese document JPS5261681, is an armature of which the metal block is entirely laminated so as to form a block of a plurality of metal sheets adjacent to one another.

Also known from Japanese document JPH08247181 is an armature of which the metal block comprises a laminated portion formed by a plurality of metal sheets which are adjacent to one another and welded together, and a solid portion to which the laminated portion is welded.

### DISCLOSURE OF THE INVENTION

The invention aims to provide an electromagnetic braking device of a similar type, which is particularly simple and efficient.

Thus, an object of the invention, in a first aspect, is an electromagnetic braking device which is configured to block a rotary shaft, comprising a friction disk which is mounted so as to be movable in translation and in rotation and configured to be secured to the rotary shaft, an outer part and an intermediate part mounted so as to be movable in translation between the friction disk and the outer part, at least one of the outer part or the intermediate part being magnetic, at least one electromagnetic actuating member and at least one mechanical actuating member which are housed in the other of the outer part or of the intermediate part, the intermediate part being configured to move in a first direction, referred to as braking toward the friction disk, when it is under the action of the at least one mechanical actuating member, and in a second direction opposite to the first direction toward the outer part when the intermediate part is under the action of the at least one electromagnetic actuating member; the electromagnetic braking device being characterized in that it further comprises a plurality of magnetic sheets which are independent of one another and movable in translation between the intermediate part and the outer part when they are under the action of the at least one mechanical actuating member and/or under the action of the at least one electromagnetic actuating member.

In the device according to the invention, the outer part is fixed and the intermediate part and the magnetic sheets are at least partially movable in translation relative to the outer part.

According to a first embodiment, the outer part is formed by a magnetic body and the intermediate part is formed by a magnetic armature.

According to a second embodiment, the outer part is formed by a magnetic armature and the intermediate part is formed by a magnetic body.

It will be noted that the body, the armature and the sheets can be made of a metal or composite material.

In each of these embodiments, the at least one electromagnetic actuating member and the at least one mechanical actuating member are housed in the body and the magnetic sheets are located against the armature under the action of the at least one mechanical actuating member.

Thus, the device is configured so that, in a braking configuration, the magnetic metal sheets are pushed by the at least one mechanical actuating member from the outer part, respectively the intermediate part, toward the intermediate part, respectively the outer part, and, in a brake release configuration, the magnetic metal sheets are at least partially moved under the action of the at least one electromagnetic actuating member from the intermediate part, respectively the outer part, toward the outer part, respectively the intermediate part, against the at least one mechanical actuating member, until coming against the outer part or the intermediate part, with the magnetic metal sheets which are deformed successively under the simultaneous action of the at least one mechanical actuating member.

If appropriate, the magnetic metal sheets can be moved against the at least one mechanical actuating member until it comes against the outer part or the intermediate part.

When they are neither under the action of the at least one mechanical actuating member nor under the action of the at least one electromagnetic actuating member, the magnetic sheets are generally flat.

It will be noted that in the first embodiment, the electromagnetic braking device is configured so that, in the braking configuration, the sheets are pushed by the at least one mechanical actuating member from an inner face of the body and accompany the movement of the armature in the first direction toward the friction disk and, in the brake release configuration, the sheets are moved under the action of the at least one electromagnetic actuating member in the second direction and are accompanied by the armature, against the at least one mechanical actuating member, until coming against the inner face of the body, with the sheets which are deformed successively under the action of the at least one mechanical actuating member.

In particular, when the braking configuration is changed over to the brake release configuration, the part(s) of the sheets that are located in the region of application of the force exerted by the at least one mechanical actuating member move more slowly than the rest of the surface of the sheets, and the rest of the surface of the sheets is deformed and comes more rapidly to abut the inner face of the body. It is the armature which is magnetically biased by the electromagnetic actuating member and, by its bulk structure, returns the sheets to shape when it moves against the at least one mechanical actuating member.

During the changeover from the brake release configuration to the braking configuration, the part(s) of the sheets that are located in the region of application of the force exerted by the at least one mechanical actuating member are moved simultaneously with the armature and more quickly, in the first direction, from the inner face of the body, than the rest of the surface of the sheets, while the rest of the surface of the sheets is deformed and is moved farther away from the inner face of the body. It can be seen that the armature is no longer magnetically biased and it moves more quickly, pushed by the sheets which themselves are pushed by the at least one mechanical actuating member, until coming into contact with the friction disk.

It will also be noted that in the second embodiment, the electromagnetic braking device is configured so that, in the braking configuration, the magnetic metal sheets are pushed by the at least one mechanical actuating member against the armature and the at least one mechanical actuating member bears on the assembly formed of the sheets and the armature in order to accompany the body in movement in the first direction toward the friction disk and, in a brake release configuration, the body is moved under the action of the at least one electromagnetic actuating member in the second direction against the at least one mechanical actuating member, until coming against the sheets and compressing them against the armature.

In particular, when the braking configuration is changed over to the brake release configuration, the part(s) of the sheets which are located in the region of application of the force exerted by the at least one mechanical actuating member remain pressed or almost pressed against the armature, and the rest of the surface of the sheets, magnetically biased by the electromagnetic actuating member, can be deformed. It is the body, moved under the effect of the electromagnetic actuating member, i.e., attracted toward the armature and also toward the sheets, which returns the sheets to their shape, or reverses the deformation that they undergo, when they are compressed between the body and the armature, in particular due to the bulk structure thereof.

When the brake release configuration changes over to the braking configuration, it is found that the armature is no longer magnetically biased and that it allows a faster movement of the body, pushed by the at least one mechanical actuating member, until coming into contact with the friction disk.

It is therefore more generally the presence of the at least one mechanical actuating member, capable of mechanically biasing the assembly formed of the armature and the totality of the sheets, which generates the successive deformation of these sheets. In particular, the deformation of the sheets results from the force of the at least one mechanical actuating member combined with the magnetic force, generated by the at least one electromagnetic actuating member, which is established or which is dissipated.

This makes it possible in particular to reduce the noise that the movement of the armature, respectively of the body, from the friction disk to the body, respectively the armature, can generate.

The time for changing over from the braking configuration to the brake release configuration can be slightly extended because the armature is magnetized only later, but this has no detrimental influence on the operation of the electromagnetic braking device.

Overall, in each of the embodiments, the time for changing over from the brake release configuration to the braking configuration is thus reduced, which is particularly safe.

This also makes it possible to reduce the noise that can be generated by the movement of the armature, respectively of the body, from the inner face of the body, respectively the armature, toward the friction disk.

Preferred features of the device according to the invention that are particularly simple, convenient and economical are presented below.

The at least one electromagnetic actuating member and the at least one mechanical actuating member can be housed fixed in the intermediate part or in the outer part.

The at least one mechanical actuating member can be configured to bias external and/or internal peripheral regions of the magnetic sheets, while the electromagnetic actuating member can be configured to generate a magnetic flux circulating in the magnetic sheets.

The ratio between a thickness of the intermediate part, respectively of the outer part, and a thickness of the magnetic sheets bearing against one another may be between approximately 0.2 and approximately 30, or even between approximately 0.2 and 5.

The electromagnetic braking device may comprise between approximately 2 and approximately 30 magnetic sheets.

Each magnetic sheet may have a thickness of between 0.3 mm and approximately 5 mm and/or each sheet may have substantially the same thickness.

The outer part or the intermediate part can have an inner face and may comprise at least one blind hole opening onto said inner face, the at least one mechanical actuating member being a compression spring which is partially housed in said blind hole and projects from said inner face until coming into contact with one of the sheets which is directly facing said inner face.

The electromagnetic braking device may comprise a plurality of compression springs which are distributed, in particular regularly, along an outer peripheral edge and/or an inner peripheral edge of said inner face.

The outer part or the intermediate part can have an inner face and may comprise a housing which is formed in the inner face, the electromagnetic actuating member comprising an electric coil which is housed in said housing and configured to generate a magnetic flux circulating in said magnetic metal sheets and in said outer part and in said intermediate part when said electric coil is supplied with electric current.

The outer part may be configured to be mechanically secured to a support, the friction disk being located axially between the intermediate part and said support.

The electromagnetic braking device may comprise at least one assembly member having a first end which is mechanically secured to said outer part and a second end which is opposite to said first end and is mechanically secured on said support such that said friction disk, said intermediate part and said sheets are located between said outer part and said support.

The electromagnetic braking device may comprise at least one connecting member having a main portion, a first end of which is configured to bear against said support and a second end, which is opposite the first end, configured to bear against said outer part, the at least one connecting member comprising a through hole which is configured such that said assembly member may pass through it.

The electromagnetic braking device may comprise a plurality of connecting members which are distributed, in particular regularly, along an outer peripheral edge of said outer part.

The device may comprise at least one connecting member which is configured to maintain a predetermined distance between the outer part and a support which is intended to clamp, together with the intermediate part, the friction disk. Each sheet can comprise a main portion, a bearing portion and a connecting portion attaching the bearing portion to the main portion, the connecting member being supported against the bearing portion of one of the sheets such that the bearing portions of all the sheets are supported against one another and for example form a block, with the bearing portions of the sheets, and therefore the block, which are placed between and held in contact between the connecting member and the outer part, each connecting portion being configured to be deformed when the main portion of the associated sheet is deformed under the action of the at least one mechanical actuating member and/or under the action of the at least one electromagnetic actuating member.

Each sheet can comprise bearing portions which are separate and at a distance from one another, each bearing portion being arranged in an external projection from the main portion or in the main portion, and the at least one connecting member is formed by a spacer.

Each sheet can comprise a bearing member extending around the main portion of the associated sheet and forming the bearing portion, the support comprising a bearing rim forming the connecting member.

The outer part can comprise at least one through hole having a first end opening onto a face turned toward said intermediate part, the at least one through hole being widened on the side of its first end and the at least one connecting member comprising a thinner end portion which is configured to be received in the at least one through hole on the side of its first end.

An object of the invention, in a second aspect, is also a mobility system, for example of the elevator or forklift type, comprising an electromagnetic braking device as described above and a rotary shaft which is integral with a friction disk of the electromagnetic braking device, with the rotary shaft which is blocked in rotation when the intermediate part has been moved in the first direction, referred to as the braking direction, and when it bears against the friction disk, and with the rotary shaft which is free to rotate when the intermediate part has been moved in the second direction opposite to the first direction and when it is away from the friction disk.

### BRIEF DESCRIPTION OF THE FIGURES

The description of the invention will now be continued by the description of an embodiment, given below by way of non-limiting illustration, with reference to the drawings mentioned below.

FIG. 1 schematically and partially depicts a mobility system provided with an assembly comprising a rotary shaft and an electromagnetic braking device according to the invention and mounted around the rotary shaft.

FIG. 2 is a partial perspective view of the assembly comprising the mobility system of FIG. 1, including in particular the electromagnetic braking device according to a first embodiment and the rotary shaft.

FIG. 3 is a view similar to that of FIG. 2, in side view.

FIG. 4 is an exploded view in perspective of the electromagnetic braking device taken in isolation.

FIG. 5 is a view similar to that of FIG. 4, according to another viewing angle.

FIG. 6 is sectional view of the electromagnetic braking device referenced VI-VI in FIG. 3.

FIG. 7 shows a detail referenced D1 in FIG. 6.

FIG. 8 is a partial sectional view of the electromagnetic braking device, in what is referred to as the braking configuration.

FIG. 9 shows a detail referenced D2 in FIG. 8.

FIG. 10 is a view similar to that of FIG. 8, showing the electromagnetic braking device in a so-called brake release configuration.

FIG. 11 shows a detail referenced D3 in FIG. 10.

FIG. 12 is a partial sectional view of the electromagnetic braking device, changing over from what is referred to as its brake release configuration to what is referred to as its braking configuration and at a first viewing angle.

FIG. 13 is a view similar to that of FIG. 4, showing an electromagnetic braking device according to a second embodiment.

FIG. 14 is a sectional view of the electromagnetic braking device of FIG. 13, in its braking configuration.

FIG. 15 is a perspective view of an electromagnetic braking device equipped according to a third embodiment.

FIG. 16 shows in perspective the electromagnetic braking device of FIG. 15 according to another viewing angle.

FIG. 17 is an exploded perspective view of the electromagnetic braking device of FIGS. 15 and 16.

FIG. 18 is a exploded perspective view of an electromagnetic braking device according to a fourth embodiment.

FIG. 19 is a partial cross-sectional view of an electromagnetic braking device according to a fifth embodiment, showing this device in a brake release configuration.

FIG. 20 is a view similar to that of FIG. 19, showing the device in a braking configuration.

FIG. 21 is a partial cross-sectional view of an electromagnetic braking device according to a sixth embodiment, showing this device in a brake release configuration.

FIG. 22 is a view similar to that of FIG. 21, showing the device in a braking configuration.

### DETAILED DESCRIPTION OF EMBODIMENTS OF THE INVENTION

FIG. 1 schematically depicts a mobility system 1, for example here of the elevator type.

This mobility system 1 comprises an elevator car 4, a rotary shaft 7 and a cable 3 connecting the elevator car 4 to the rotary shaft 7.

The mobility system 2 also comprises an electric motor 2 powered with electric current and configured to drive the rotary shaft 7 in rotation.

When the rotary shaft 7 is rotated by the electric motor 2, the cable 3 winds or unwinds, in the direction of drive, around the rotary shaft 7 and the elevator car 4 is allowed to rise or descend.

The mobility system 1 and in particular the elevator car 4 may require prolonged safe stops and for this purpose it comprises an electromagnetic braking device 5.

The electromagnetic braking device 5 is mounted on the rotary shaft 7 and is configured either to brake, or block in rotation, the rotary shaft 7, or to leave it free.

The electromagnetic braking device 5 is electrically powered and it may be the same current supply source as the electric motor 2.

In particular, the electromagnetic braking device 5 can be configured to rotationally brake the rotary shaft 7 when it is not supplied with current, which also makes it possible to secure the mobility system 1 for example in the event of an electrical power failure.

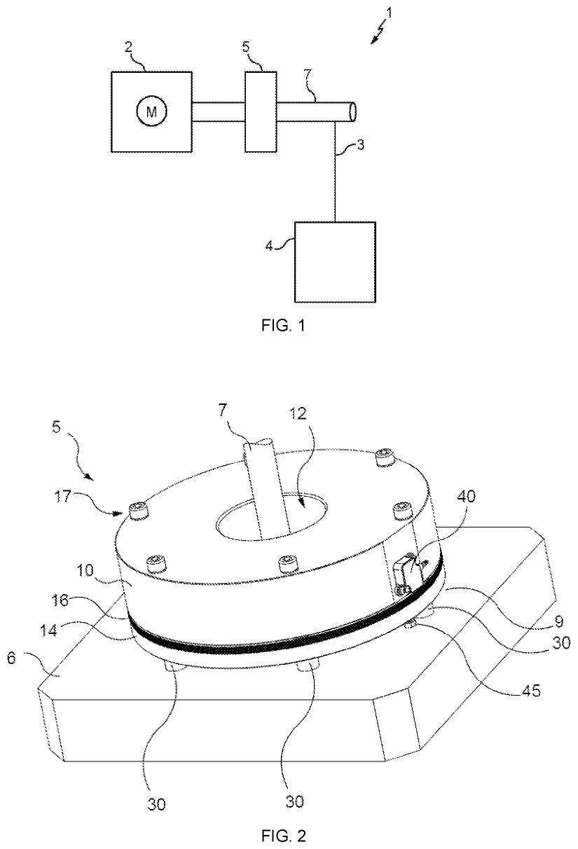

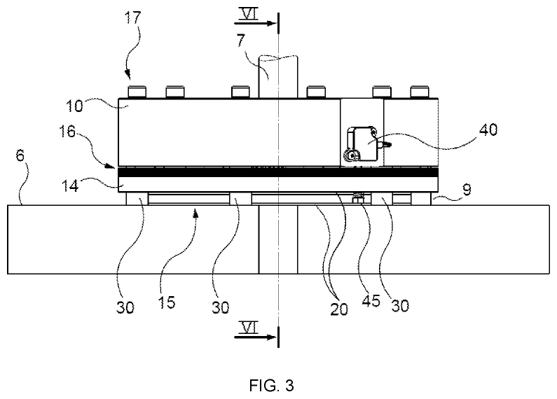

The electromagnetic braking device 5, according to a first embodiment, is best viewed in FIGS. 2 and 3.

The electromagnetic braking device 5 is mechanically secured on a support 6, here formed by a casing, by means of assembly screws 17 for example.

The electromagnetic braking device 5 has a central opening 12, here of circular shape, which defines a passage for the rotary shaft 7.

The electromagnetic braking device 5 comprises a body 10, also referred to as a shell, in this case having a generally cylindrical shape and annular cross section.

The body 10 is here made of a magnetic metal material.

The braking device 5 further comprises a plurality of magnetic metal sheets 16, a magnetic metal armature 14 and a friction disk 15 which are placed between the body 10 and the casing 6.

The braking device 5 further comprises a connecting member formed by spacers 30 arranged between the body 10 and the casing 6 in order to define a space 9 between these elements. The spacers 30 are configured to maintain a predetermined distance between the body 10 and the support 6.

The magnetic metal sheets 16, the magnetic metal armature 14 and the friction disk 15 are housed in this space 9 formed between the body 10 and the support 6.

In particular, the sheets 16 are arranged between the body 10 and the armature 14, the armature 14 is arranged between the sheets 16 and the friction disk 15, and the friction disk 15 is arranged between the armature 14 and the support 6.

In this first embodiment of the electromagnetic braking device 5, the body 10 forms an outer part while the armature 14 forms an intermediate part.

In the example shown, the sheets 16 and the armature 14 are mounted so as to be movable in translation on the rotary shaft 7 and relative to the body 10 in the space 9. The body 10 is here fixed relative to the support 6. The friction disk 15 is for its part configured to be mechanically secured to the rotary shaft 7.

The friction disk 15 comprises a lining 20 on a face turned toward the armature 14 and a lining 20 on an opposite face of the friction disk 15 turned toward the support 6. Each lining 20 has an annular section and is arranged at least at the periphery of the friction disk 15.

The electromagnetic braking device 5 is configured such that, when it is not electrically powered, the sheets 16 and the armature 14 move in a first direction called braking toward the friction disk 15 until the armature 14 comes to bear against the friction disk 15 in order to block it in rotation and thus prevent rotation of the rotary shaft 7.

On the other hand, when the electromagnetic braking device 5 is electrically powered, the sheets 16 and the armature 14 move in a second direction opposite the first direction, moving away from the friction disk 15 so as to release it and allow its rotation.

The electromagnetic braking device 5 is also provided with a position sensor 40 of the intermediate part mounted on a peripheral face of the body 10 and designed to detect the position of the armature 14 so as to check whether the armature is or is not in contact with the friction disk 15.

The position sensor 40 here is provided with an external electronic housing and what is referred to as a plunger mechanism 45 which is mechanically secured to the armature 14 and which in particular comprises a rod partially protruding from the armature 14 in the direction of the friction disk 15, and around which a spring member is mounted.

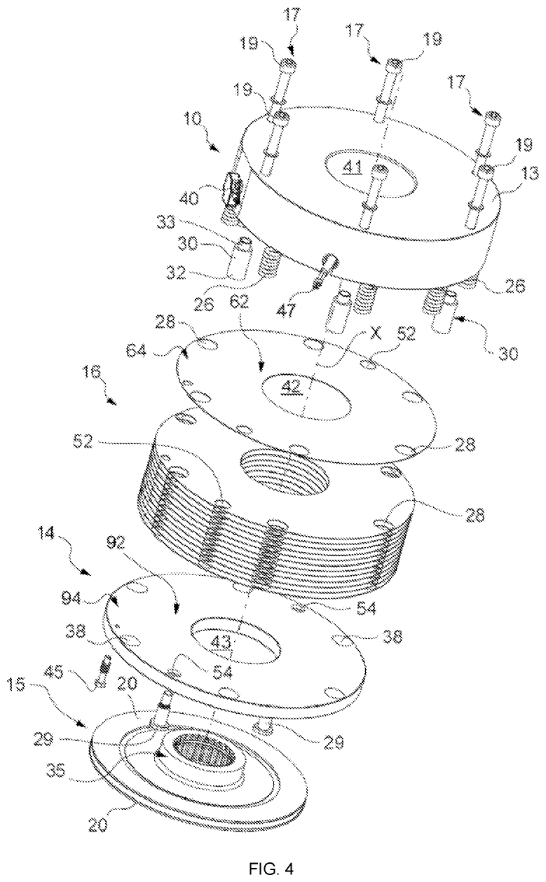

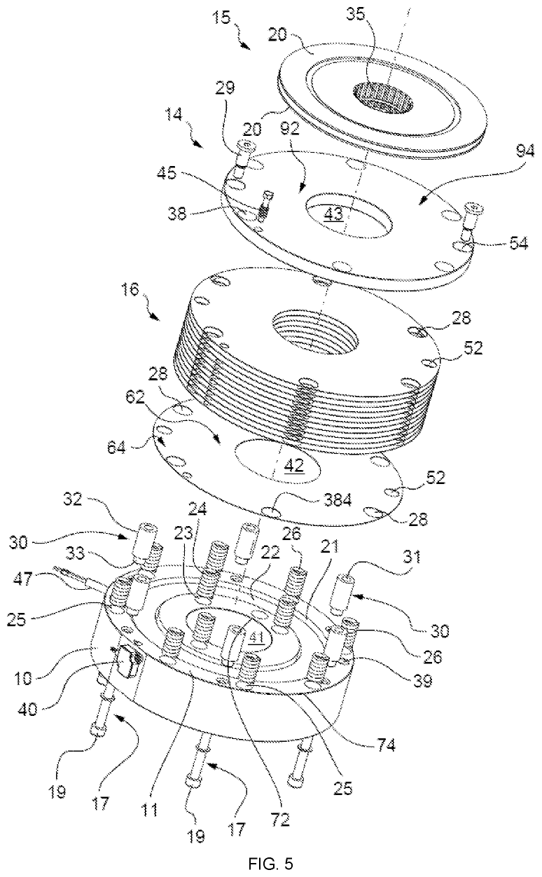

FIGS. 4 to 7 show the electromagnetic braking device 5 in more detail.

In particular, the body 10 of the electromagnetic braking device 5 has an inner face 11 and an outer face 13 axially opposite the inner face 11.

The inner face 11 comprises an inner peripheral edge 72 and an outer peripheral edge 74.

The body 10 is provided with a central orifice 41 around which the inner peripheral edge 72 is located and which delimits the central opening 12 of the electromagnetic braking device 5.

The body 10 is provided with a housing 21 opening onto its inner face 11. The housing 21 is concentric to the central orifice 41 of the body 10 and arranged between the inner and outer peripheral edges 72 and 74 of the inner face 11 of the body 10.

The electromagnetic braking device 5 comprises an electric coil 22 which is received in the housing 21 while being substantially flush with the inner face 11 of the body 10. The coil 22 is supplied by conductive wires 47 passing through a peripheral face of the body 10.

The body 10 is also provided with blind holes 23 and 25 opening onto its inner face 11.

The electromagnetic braking device 5 also comprises internal and external springs 24 and 26 formed here by coil springs. As a variant, it could involve spring washers or any other type of elastic mechanical system capable of exerting a bias.

The internal and external springs 24 and 26 are at least partially housed in the blind holes 23 and 25 and extend protruding from the inner face 11 of the body 10.

The internal and external springs 24 and 26 are provided to come into contact with one of the magnetic metal sheets 16 which are located directly facing the inner face 11 of the body 10.

In particular, the body 10 is provided with a first series of blind holes 23 which are regularly distributed along the inner peripheral edge 72 of the inner face 11 and a second series of blind holes 25 which are regularly distributed along the outer peripheral edge 74 of the inner face 11.

The first and second series of blind holes 23 and 25 are thus arranged on either side of the housing 21 which separates them.

The blind holes 23 of the first series receive the internal compression springs 24 while the blind holes 25 of the second series receive the external compression springs 26.

The depth of the blind holes 23 and 25 can be identical or different from one series to the other, while the internal and external springs 24 and 26 can be identical or different, in particular with regard to their stiffness, length, diameter and compression state.

In the illustrated example, the first series is formed by three blind holes 23 while the second series is formed by eight blind holes 25.

The blind holes 23 and 25 of each series are here distributed concentrically.

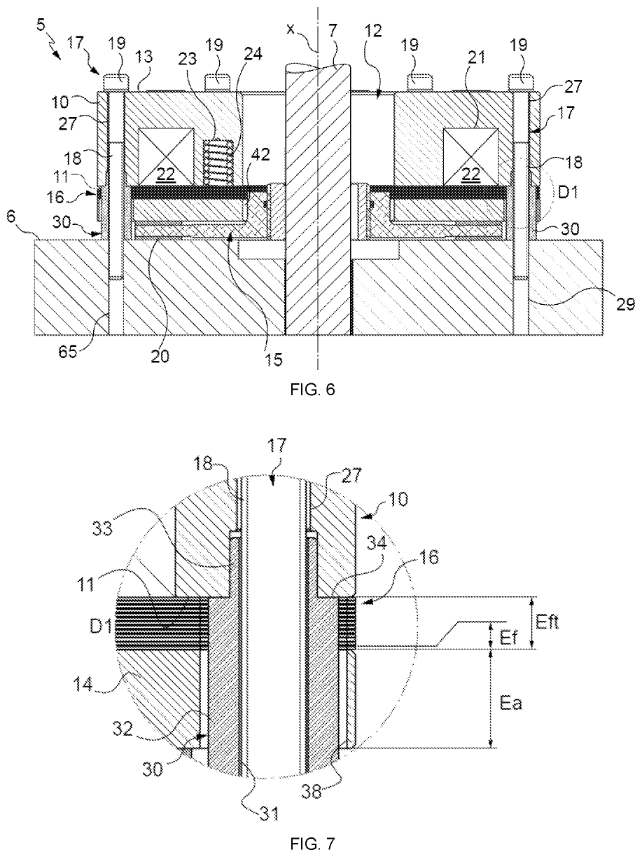

The body 10 is also provided with through holes 27 (FIG. 6) which are here regularly distributed along the outer peripheral edge 74 of the inner face 11 of the body 10 and extend in parallel with the central axis X, which through holes 27 are configured to have assembly screws 17 pass through them.

Each through hole 27 opens at a first end on the inner face 11 of the body 10 and at a second end, opposite the first end, on the outer face 13 of the body 10.

The first end of each through hole 27 opening onto the inner face 11 of the body 10 is widened, as can be seen in FIG. 7.

The body 10 is also provided with blind holes 39 which here are located along the outer peripheral edge 74 of the inner face 11 of the body 10 and extend parallel to the central axis X. The body 10 is here provided with two blind holes 39 which are diametrically opposed. The blind holes 39 are configured to receive guide pins 29 of the braking device.

When they are received in the blind holes 39, the guide pins 29 project from the inner face 11 of the body 10.

The guide pins 29 are configured on the one hand to guide the sheets 16 and the armature 14 in translation in the space 9 and on the other hand to ensure resistance to the force of the armature 14 when the latter comes to bear against the friction disk 15.

The spacers 30 of the electromagnetic braking device 5 comprise a through hole 31 which is configured to have an assembly screw 17 pass through it.

The spacers 30 are thus regularly distributed along the outer peripheral edge 74 of the inner face 11 of the body 10 and are arranged so that the through hole 31 is facing the through holes 27 of the body 10.

In particular, the spacers 30 are provided, at a first end, with a main portion 32 which is configured to bear on the support 6 and, at a second end opposite the first end, with a thinner portion 33 which is connected to the main portion 32 by a shoulder 34. The widened first end of each through hole 27 is configured to receive the thinner portion 33 of each spacer 30 until the inner face 11 of the body 10 abuts against the shoulder 34.

Thus, the main portion 32 has a length, along the central axis X, which corresponds to the distance separating the body 10 from the support 6.

In the example illustrated, this distance is equal to the sum of the dimensions, along the central axis X, of the disk 15, of the armature 14 of sheets 16, and of an air gap in particular allowing the mobility of these elements.

It is thus possible to adjust the distance separating the body 10 from the support 6 by replacing the spacers 30 with spacers having a main portion 32 that has different dimensions.

In other words, the air gap can be adjusted by selecting a predefined length of the main portion 32.

In a variant not shown, this could make it possible to form a device having an air gap of variable size.

In another variant not shown, the shoulder of the spacer can come into abutment against the sheet furthest from the body.

In order to attach the body 10 to the support 6, the support 6 is provided with tapped holes 65 which are complementary with the through holes 27 of the body 10, which tapped holes 65 are configured to receive the assembly screws 17.

As shown in FIG. 6, each assembly screw 17 is provided with a threaded portion 18 at a first end and a head 19 at a second end opposite the first end.

The assembly screws 17 are inserted by their first end into the through holes 27 until the head 19 abuts against the outer face 13 of the body 10. The threaded portion 18 protrudes from the side of the inner face 11 to be screwed into the tapped holes 65 of the support 6.

The magnetic metal sheets 16 are provided with a central orifice 42 which delimits the central opening 12 of the electromagnetic braking device 5. Each sheet 16 has a substantially identical annular section.

The magnetic metal sheets 16 have an inner peripheral region 62 and an outer peripheral region 64 and here have a constant thickness Ef.

Each magnetic metal sheet 16 comprises first guide through holes 28 arranged substantially in the outer peripheral region 64 of each sheet 16. These first guide holes 28 are formed in a complementary manner to the through holes 27 of the body 10 and of the tapped holes 65 of the support 6. Each first guide hole 28 is configured such that the main portion 32 of each spacer 30 may pass through it.

Each magnetic metal sheet 16 also comprises second guide through holes 52 arranged substantially in the outer peripheral region 64 of each sheet 16. The second guide holes 52 are configured to receive the guide pins 29 with an adjustment allowing the movement of the sheets 16 along the guide pins 29. This makes it possible on the one hand to guide the magnetic metal sheets 16 in translation between the body 10 and the support 6, and on the other hand to block the rotation of the sheets 16 around the central axis X of the body 10.

The magnetic metal sheets 16 have a solid surface facing the blind holes 23 and 25 of the body 10 such that the internal and external springs 24 and 26 bear against the sheets 16.

In the example shown, the electromagnetic braking device 5 comprises thirteen identical magnetic metal sheets 16.

As a variant, the electromagnetic braking device may comprise more or fewer identical magnetic metal sheets 16, and more generally there may be between two and thirty sheets that are identical or different.

Here each sheet 16 has a thickness Ef of approximately 0.5 mm. More generally, the sheets 16 may have a thickness Ef of between approximately 0.3 mm and approximately 5 mm.

When they bear against one another, the plurality of magnetic metal sheets 16 has a predetermined thickness Eft which corresponds to the sum of the thicknesses Ef of each sheet 16.

The sheets 16 may be electrically insulated from one another, for example by being coated with a varnish. The sheets 16 may be provided with anti-corrosion treatment, just like the armature 14 and the body 10.

The armature 14 has a bulk structure and is in the form of a plate with a constant thickness Ea.

The armature 14 is provided with a central orifice 43 delimiting the central opening 12 of the electromagnetic braking device 5.

The armature 14 has an inner peripheral region 92 and an outer peripheral region 94.

The armature 14 is provided with third guide holes 38 which pass through and are arranged substantially in the outer peripheral region 94 of the armature 14. The third guide holes 38 are formed in a complementary manner to the first guide holes 28 of the magnetic metal sheets 16. Each third guide hole 38 is configured to have the main portion 32 of each spacer 30 pass through it.

The armature also comprises fourth guide holes 54 which pass through and arranged substantially in the outer peripheral region 94 of the armature. The fourth guide holes 54 are configured to receive the guide pins 29 with an adjustment allowing the movement of the armature 14 along the guide pins 29.

In particular, the adjustment between the second and fourth guide holes 52 and 54 and the guide pins 29 is less than the adjustment between the first and third guide holes 28 and 38 and the spacers 30.

The armature 14 here has a thickness Ea of approximately 12 mm. More generally, the armature 14 can have a thickness Ea of between approximately 0.5 mm and approximately 40 mm. The thickness Ea of the armature 14 is much greater than the thickness Ef of each magnetic metal sheet 16.

The ratio between the thickness Ea of the armature 14 and the thickness Eft of the magnetic metal sheets 16 bearing against one another is here equal to approximately 1.86. More generally, this ratio may be between approximately 0.2 and approximately 30, or even between approximately 0.2 and 5.

The armature 14 and the magnetic metal sheets 16 are distinct elements, and the sheets 16 themselves are distinct elements so as to be able to move away from one another. In other words, the armature 14 is separate from the sheets 16 and the sheets 16 are separate from one another.

The friction disk 15 has a section which is smaller than that of the armature 14 and the sheets 16 so that the spacers 30 are located around the friction disk 15.

The friction disk 15 comprises a hub 35 having a protruding part extending axially toward the body 10. The hub 35 is here splined.

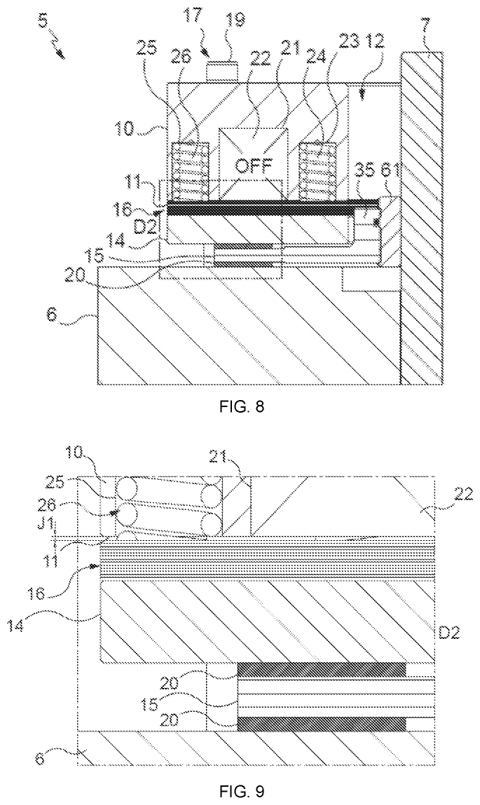

As shown in FIG. 8, the rotary shaft 7 comprises a splined portion 61 complementary to the hub 35. The splined portion 61 is configured to slidably engage the hub 35. In this way, the friction disk 15 can rotate with the rotary shaft 7 and slide axially along the splined portion 61 of the rotary shaft 7.

The protruding part of the hub 35 is configured to be received in the central orifices 42 and 43 provided respectively on the sheets 16 and on the armature 14.

FIGS. 8 to 11, then 12, respectively show the electromagnetic braking device 5 in a braking or brake release configuration, and then during the changeover from the brake release configuration to the braking configuration.

As can be seen in FIGS. 8 and 9, the electromagnetic braking device 5 is in its braking configuration in which the electric coil 22 is at rest, i.e., not supplied with current, and the armature 14 is against the friction disk 15, under the action of the internal and external springs 24 and 26.

The internal and external springs 24 and 26 thus act on the armature 14 via the sheets 16. The armature 14 is pushed in the first direction until coming into contact with the lining 20 of the friction disk 15 and pushes the latter against the casing 6.

In particular, the inner springs 24 are configured to act toward the inner peripheral region 62 of the sheets 16, while the outer springs 26 are configured to act toward the outer peripheral region 64 of the sheets 16.

The rotary shaft 7 is thus blocked in rotation by clamping the friction disk 15 between the armature 14 and the support 6 under the action of the internal and external springs 24 and 26.

In this configuration, a space J1 (FIG. 9) corresponding to the air gap is formed between the inner face 11 of the body 10 and the sheets 16. The space J1 can be adjusted by modifying the thickness Ea and/or the number of sheets 16, the thickness Ea of the armature 14 and/or the size of the main portion 32 of the spacers 30.

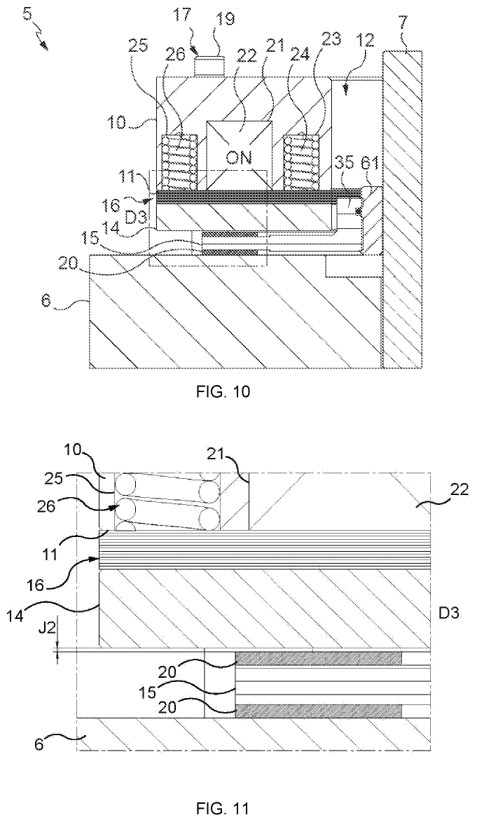

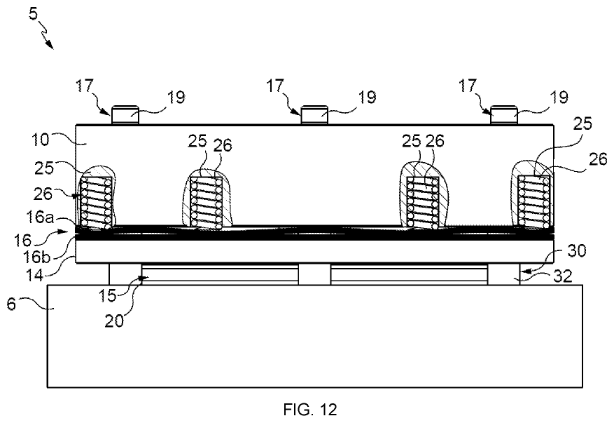

As can be seen in FIGS. 10 and 11, the electromagnetic braking device 5 is in its brake release configuration in which the electric coil 22 is supplied with current.

The electric coil 22 is configured to generate a magnetic flux circulating in the magnetic metal sheets 16, in the body 10 and in the armature 14.

The magnetic flux generated by the electric coil 22 thus attracts the magnetic metal sheets 16 and the armature 14 against the inner face 11 of the body 10.

For this purpose, the armature 14 and the sheets 16 are made of a magnetic material. For example, the armature 14 can be made of cast iron, steel such as non-alloy steel of the C10, C22 or C45 type, while the sheets 16 can be made of steel.

The armature 14 and the sheets 16 are moved under the action of the magnetic flux in the second direction opposite to the first direction, directed toward the inner face 11 of the body 10 until the armature 14 presses the sheets 16 against the inner face 11 of the body 10.

In this configuration, a space J2 (FIG. 11) corresponding to the air gap is formed between the armature 14 and the friction disk 15. The space J2 can be adjusted in the same way as the space J1 located between the inner face 11 of the body 10 and the sheets 16.

In the brake release configuration, the brake disk 15 is thus at a distance from the armature 14 and from the support 6 and is free to rotate.

In each of the braking or brake release configurations described above, the sheets 16 are pushed in the first direction against the armature 14 and are compressed between them, in particular at the regions of application of the force exerted by the internal and external springs 24 and 26.

In FIG. 12, the electromagnetic braking device 5 is in an intermediate configuration corresponding to the changeover from the braking configuration, shown in FIGS. 8 and 9, to the brake release configuration, shown in FIGS. 10 and 11.

During the changeover from the braking configuration to the brake release configuration, the electric coil 22 is supplied with current and the magnetic flux generated by this electric coil 22 gradually circulates from the sheet 16 directly facing the inner face 11 of the body 10 to the armature 14.

The gradual circulation of the magnetic flux causes the sheets 16 and then the armature 14 to move successively and progressively in the second direction.

In the example shown, there are sheets, denoted 16a to distinguish them from the magnetic metal sheets 16, which are attracted toward the inner face 11 of the body 10 under the action of the magnetic flux generated by the electric coil 22 and sheets, denoted 16b to distinguish them, which are not yet magnetized or subjected to a magnetic flux sufficient to attract them.

The sheets 16b are therefore still compressed against the armature 14 at least at the regions of application of the force exerted by the internal and external springs 24 and 26 while the magnetized sheets 16a are deformed at remaining regions until coming into abutment against the inner face 11 of the body 10 under the action of the magnetic flux generated by the electric coil 22.

The action of the internal and external springs 24 and 26 as well as the action of the magnetic flux generated by the electric coil 22 thus contributes to the deformation of the magnetized sheets 16b.

This is possible on the one hand because the sheets 16 have a sufficiently low rigidity that does not allow them to compress the internal and external springs 24 and 26 by being under the action of the magnetic flux, and on the other hand because they are independent of one another so that they can move away in the first direction.

The magnetized sheets 16b are deformed radially between each of the application regions from the force exerted by the external springs 26 and are also deformed circumferentially between each of the application regions from the force applied by the internal and external springs 24 and 26.

The armature 14 therefore is separated from the friction disk 15 when it is in turn magnetized until it comes against the sheets 16. The sheets 16 are thus reshaped between the armature 14 and the inner face 11 of the body 10.

This is possible thanks to the bulk structure of the armature 14.

The kinetic energy of the armature 14 moving in the second direction is dissipated by virtue of the sheets 16, which in particular makes it possible to reduce the noise when the device 5 changes from its braking configuration to its brake release configuration.

The operation of the electromagnetic braking device 5 is quite similar when the brake release configuration is changed to the braking configuration.

It differs in particular in that the electric coil 22 is no longer supplied with current and the magnetic flux is gradually dissipated from the armature 14 to the sheet 16 directly facing the inner face 11 of the body 10, causing the successive and progressive movement of the armature 14 and the sheets 16.

The armature 14 is thus moved in the first direction before the sheets 16 as soon as the magnetic flux is no longer sufficient to attract it so that there is a space between the inner face 11 of the body 10 and the sheet 16 directly adjacent to the inner face 11, which space allows the magnetized sheets 16b to be deformed under the action of the inner and outer springs 24 and 26.

The gradual dissipation of the magnetic flux causes a successive and progressive movement of the sheets 16 in the first direction, thus forming a plurality of air gaps between the sheets 16. These air gaps generate a plurality of magnetic fluxes, or magnetic flux bridges, between the inner face 11 of the body 10 and the armature 14, which make it possible to dissipate the magnetic flux in the armature 14 more quickly.

The sheets 16 are successively moved to come against the armature 14, which in particular makes it possible to reduce the speed of movement of the armature 14 against the friction disk 15.

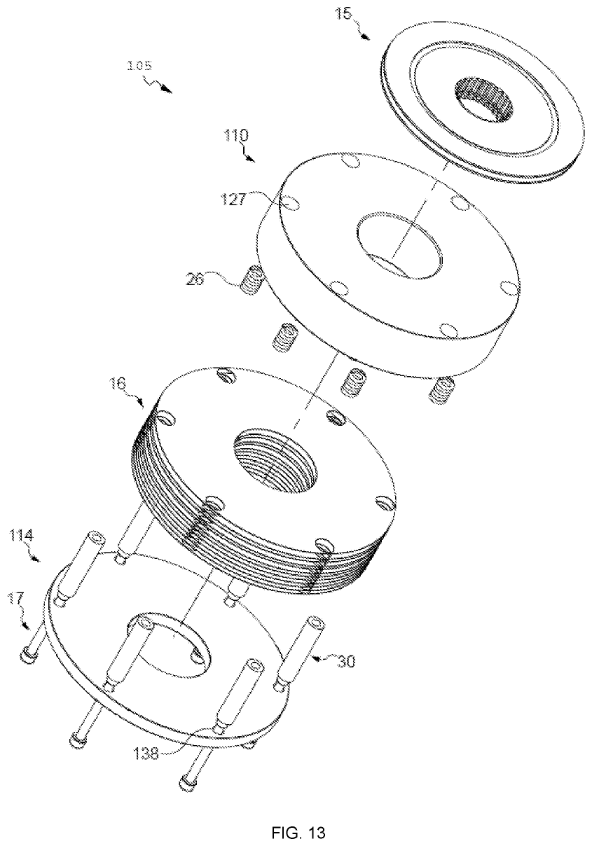

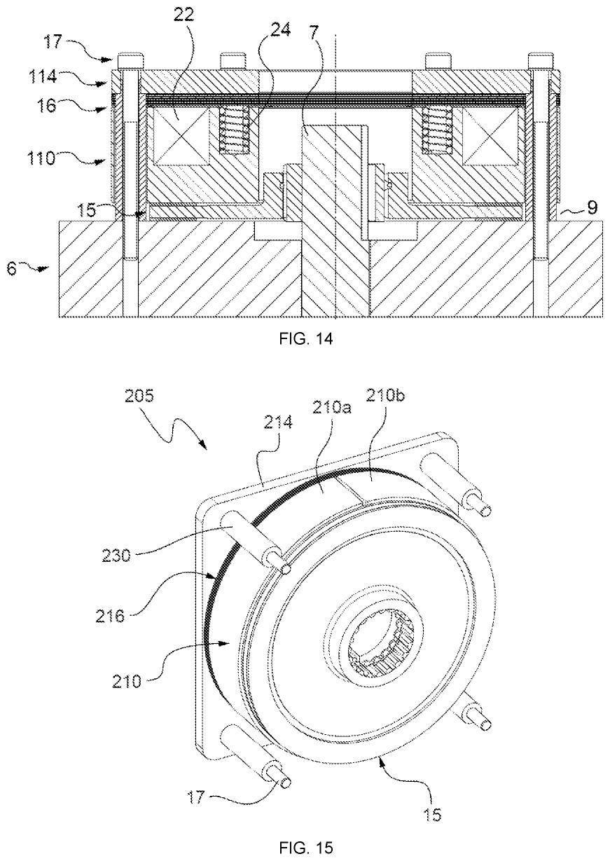

FIGS. 13 and 14 show the electromagnetic braking device according to a second embodiment in which only the arrangement of the body and the armature differs from the electromagnetic braking device visible in FIGS. 2 to 12.

To simplify the description, the same numerical references were therefore used except for the body and the armature for which similar references were used but adding 100.

In this device 105, the spacers 30 are arranged between the magnetic armature 114 and the support 6 in order to define a space between these elements.

The spacers 30 are here configured to maintain a predetermined distance between the armature 114 and the support 6. The magnetic metal sheets 16, the body 110 and the friction disk 15 are received in the space 9 formed between the armature 114 and the support 6.

In particular, a first end of the main portion of each spacer 30 is configured to bear against the support 6 and a second end opposite the first end is configured to bear against the armature 114.

In a variant not shown, the second end of each spacer can be configured to bear against the sheet furthest from the armature.

The assembly screws 17 pass through the through hole of each spacer. In particular, the assembly screws 17 are inserted by their first end into the through holes until the head comes into abutment against the armature 114. The threaded portion protrudes from the side of the first end of the spacer 30 to be screwed into the tapped holes of the support 6.

The sheets 16 are arranged between the body 110 and the armature 114, the body 110 is arranged between the sheets 16 and the friction disk 15 is arranged between the body 110 and the support 6.

In this second embodiment of the electromagnetic braking device 5, the body 110 forms the intermediate part while the armature 114 forms the outer part. Indeed, the sheets 16 and the body 110 are mounted so as to be movable in translation on the rotary shaft 7 and relative to the armature 114 in the space 9, while the armature 114 is fixed relative to the support 6.

The electromagnetic braking device 105 is configured so that, when it is not electrically energized, the sheets 16 and the body 110 move in the first direction, referred to as braking toward the friction disk 15, until the body 110 comes to bear against the friction disk 15 in order to block it in rotation and thus prevent the rotation of the rotary shaft 7.

On the other hand, when the electromagnetic braking device 105 is electrically energized, the sheets 16 and the body 110 move at least partially in the second direction, moving away from the friction disk 15 so as to release it and allow its rotation.

The position sensor is provided here to detect the position of the body 110 so as to check whether or not the body 110 is in contact with the friction disk 15. The plunger mechanism (not shown) is mechanically secured on the body 110 and the rod it comprises partially protrudes from the body 110 in the direction of the friction disk 15, and around which a spring member is mounted.

The through holes 127 are here configured such that the main portion of each spacer 30 may pass through them. Unlike the first embodiment, the through holes 127 have no widened end but have a constant section allowing the movement of the body 110 along the main portion of the spacers 30.

The third guide holes 138 are configured to receive the thinner portion of the spacers 30 as well as the assembly screws 17.

Each third guide hole 138 opens at a first end onto one face of the armature 114 turned toward the sheets 16 and at a second end, opposite the first end, onto a face opposite the face turned toward the sheets 16.

In particular, the first end of each third guide hole 138 opening onto the face turned toward the sheets 16 is widened here and configured to receive the thinner portion of each spacer 30 until the face of the armature 114 turned toward the sheets 16 comes into abutment against the shoulder.

It is thus possible to adjust the distance separating the armature 114 from the support 6 by replacing the spacers 30 with spacers having a main portion which has different dimensions.

FIG. 14 shows the electromagnetic braking device 105 in more detail.

The assembly screws 17 are inserted by their first end into the third guide holes 138 until the head comes into abutment against the face of the armature 114 on the side opposite the sheets 16. The threaded portion protrudes from the face of the armature 114 turned toward the sheets 16 in order to be screwed into the tapped holes 65 of the support 6.

The main portion of the spacers 30 is thus configured on the one hand to guide the sheets 16 and the body 110 in translation in the space 9 and, on the other hand, to ensure resistance to the force of the body 110 when the latter bears against the friction disk 15.

The friction disk 15 has a section smaller than that of the body 110, the outer face of which is configured to come into contact with one of the linings of the friction disk 15.

The protruding part of the hub is configured to be received in the central opening of the body 110.

When the electromagnetic braking device 105 is in its braking configuration, the body 110 is moved in the first direction, toward the friction disk 15, under the action of the internal and external springs 24 and 26 and the sheets 16 are against the armature 114, also under the action of the internal and external springs 24 and 26.

In particular, the internal and external springs 24 and 26 act on the armature 114 via the sheets 16, and push the body 110 by counter-reaction in the first direction until coming into contact with the lining of the friction disk 15 and pushing the latter against the support 6.

The rotary shaft 7 is thus blocked in rotation by clamping the friction disk 15 between the body 110 and the support 6 under the action of the internal and external springs 24 and 26.

In this configuration, a space (not shown) is formed between the inner face of the body 110 and the sheets 16.

When the electromagnetic braking device 105 is in its brake release configuration, the body 110 is moved in the second direction under the action of the magnetic flux generated by the electric coil 22 and the sheets 16 are against the armature 114.

The friction disk 15 is thus spaced apart from the body 110 and the support 6 and is therefore free to rotate.

In this configuration, a space (not shown) is formed between the outer face of the body 110 and the friction disk 15.

In each of the braking or brake release configurations described above, the sheets 16 are pushed in the second direction against the armature 114 and are compressed between them, in particular at the regions of application of the force exerted by the internal and external springs 24 and 26.

When the device 105 is in an intermediate configuration corresponding to the changeover from the braking configuration to the brake release configuration, the gradual circulation of the magnetic flux causes the successive and progressive movement of the part of the sheets 16 located in the region of application of the magnetic flux in the first direction, then the movement of the body 110 in the second direction.

The sheets which are not yet magnetized or subjected to a magnetic flux sufficient to attract them are therefore further compressed against the armature 114 at least in the regions of application of the force exerted by the internal and external springs 24 and 26 while the magnetized sheets are deformed in the remaining regions under the action of the magnetic flux until the inner face of the body 110 comes into contact with these magnetized sheets.

When the magnetic flux is sufficiently high, the body 110 is therefore detached from the friction disk 15 until it comes against the sheets 16 which are reshaped by compression between the inner face of the body 110 and the armature 114.

The kinetic energy of the body 110 moving in the second direction is dissipated by virtue of the sheets 16, which in particular makes it possible to reduce the noise when device 105 changes from its braking configuration to its brake release configuration.

When the device 105 is in an intermediate configuration corresponding to the changeover from the brake release configuration to the braking configuration, the gradual dissipation of the magnetic flux causes the movement of the body 110 in the first direction as soon as the magnetic flux is no longer sufficient so that there is a space between the inner face of the body 110 and the sheet 16 directly adjacent to the inner face, at least in the regions of application of the force exerted by the inner and outer springs 24 and 26, which space allows the sheets still magnetized to be deformed under the action of the remaining magnetic flux at the regions of application of the force exerted by the inner and outer springs 24 and 26.

The gradual dissipation of the magnetic flux causes a reversal of the successive and progressive deformation of the sheets 16 and therefore of the plurality of air gaps between the sheets 16.

The part(s) of the sheets 16 located in the region of application of the force exerted by the internal and external springs 24 and 26 remain compressed against the armature 114.

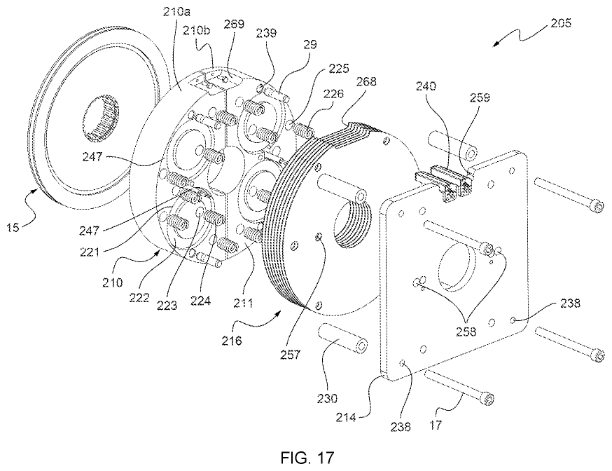

FIGS. 15 to 17 show an electromagnetic braking device according to a third embodiment, of the same type as the one described with reference to FIGS. 13 and 14, but in which the body, the armature and the sheets differ from the latter.

To simplify the description, the same numerical references have therefore been used except for the body, the armature, the sheets, the spacers and the position sensor of the intermediate part for which similar references were used but adding 200.

In this device, the body 210 is formed in two identical parts 210a and 210b, each part having a half-circle section. The parts 210a and 210b are independent of one another.

The body 210, on its inner face 211, has a plurality of housings 221 of closed contour, opening onto the inner face 211. In the example shown, there are four housings 221, the parts 210a and 210b of the body 210 each have two housings 221. The housings 221 are identical and define a circular contour.

In each housing 221, an electric coil 222 of complementary shape, i.e., of circular section, is received. Thus, the electromagnetic braking device 205 comprises four coils energized independently of one another. Thus, when a coil 222 received in a housing 221 of one of the parts 210a and 210b is energized, this part moves independently of the other part of the body 210.

The blind holes 223 are arranged inside the closed contours defined by each housing 221, while the blind holes 225 are arranged on the outside. As such, the blind holes 223 and 225 are not regularly distributed along an inner peripheral edge and an outer peripheral edge of the inner face 211 of the body 210 as in the embodiments described above. The inner face 211 of the body 210 here has four blind holes 223 distributed inside each of the closed contours formed by the housings 221. The internal compression springs 224 are received in the blind holes 223 while the external compression springs 226 are received in the blind holes 225.

The body 210 is here provided with four blind holes 239 configured to receive the guide pins 29. Each portion 210a, 210b is provided with two blind holes 239 which are arranged along the outer peripheral edge 274 of the inner face 211 of the body 210.

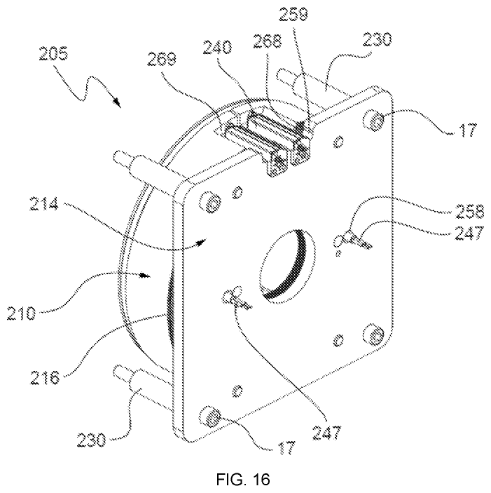

The armature 214 here has a generally square shape. The through holes 238 for the passage of the assembly screws 17 are located at each corner of the armature 214 such that, as shown in FIGS. 15 and 16, the assembly screws 17 and the spacers 230 extend outside the body 210. The body 210 and the sheets 216 are thus devoid of through holes for the passage of the assembly screws and the spacers.

The spacers 230 here have a constant section. In other words, the spacers 230 do not include a thinner portion, unlike the embodiments described above.

The position sensor 240 provided to detect the position of the body 210 is attached to the armature 214 and comprises two protruding rods extending toward the body 210. In order to integrate the position sensor 240 into the armature 214, the armature 214 has a notch 259 in which the position sensor 240 is attached. The rods of the position sensor 240 extending to the body 210, the sheets 216 and the body 210 also have a notch 268 and 269. It should be noted that the notch 269 of the body 210 is blind in order to form a reference surface allowing the sensor to determine the position of the body 210.

Unlike the embodiment shown in FIGS. 2 to 12, the conducting wires 247 serving to supply the coils 222 extend from the inner face 211 of the body 210 and not from its peripheral face. Each of the parts 210a and 210b has a hole located between the housings 221 for the passage of conductive wires 247.

In order for the conducting wires 247 not to be exposed to the outside of the device 205, the sheets 216 and the armature 214 are respectively provided with holes 257 and 258 for the conducting wires 247 to pass through.

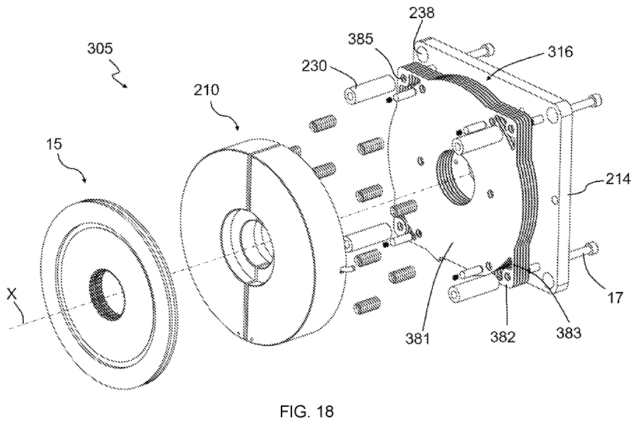

FIG. 18 shows an electromagnetic braking device according to a fourth embodiment, of the same type as those described with reference to FIGS. 2 to 17, but with different sheets.

To simplify the description, the same numerical references were therefore used except for the sheets for which similar references were used, but adding 300.

In this device bearing the reference 305, each sheet 316 comprises a main portion 381 which is generally similar to the shape of the sheets of the embodiments described previously with reference to FIGS. 2 to 17.

Each sheet 316 comprises, in addition to the main portion 381, bearing portions 382 extending radially projecting from the main portion 381. The bearing portions 382 are connected to the main portion 381 by connecting portions 383.

Each bearing portion 382 is provided with a through hole 385. The through holes 385 are aligned with the holes 238 of the armature 214, which allows the assembly screws 17 to pass.

Here the spacers 230 have a cross section of which the dimensions are greater than those of the through holes 385. Thus, the second ends of the spacers 230 bear against the bearing portions 382 of one of the sheets 316, namely the sheet furthest from the armature 214.

The bearing portions 382 of all the sheets 316 are supported against one another and for example form separate blocks which are placed between and held in contact between the spacers 230 and the armature 214. Thus, the support portions 382 are held fixed relative to the armature 214.

In the example shown, each spacer 230 has a length equal to the sum of the dimensions, along the central axis X, of the disk 15, the body 210 and the air gap.

In other words, the length of the spacers 230 does not include the thickness of the sheets 316. This makes it possible to eliminate any manufacturing tolerances of the sheets in the definition of the air gap.

In addition, in operation, the bearing portions 382 do not interfere with the movement and deformation of the main portions 381 of the sheets 316. Indeed, the sheets 316 are configured such that the connecting portions 383, located between the bearing portions 382 and the main portions 381, allow the movement and deformation of the main portions 381 while having the bearing portions 382 stationary. In this way, the independence of the main portions 381 of the sheets 316 is preserved.

In other words, each connecting portion 383 is configured to be deformed when the associated main portion 381 is deformed under the action of the at least one mechanical actuating member and/or under the action of the at least one electromagnetic actuating member.

Of course, the device 305 may comprise more or fewer bearing portions, which may be arranged differently around the main portion.

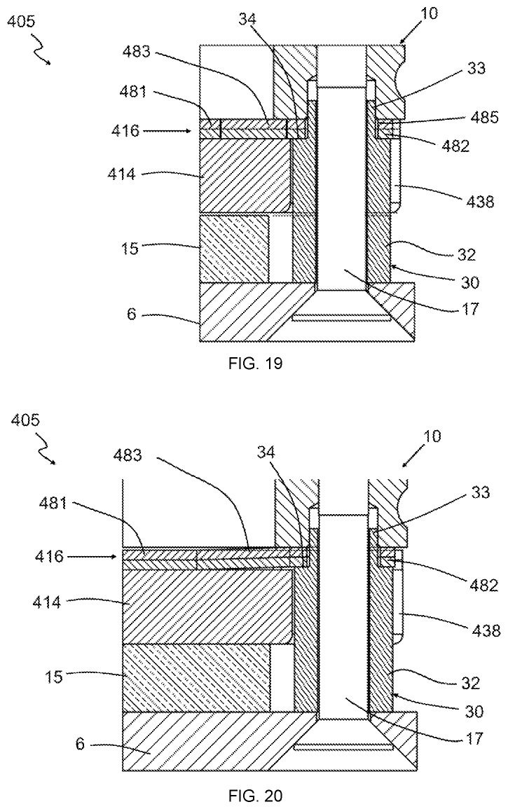

FIGS. 19 and 20 show an electromagnetic braking device according to a fifth embodiment, of the same type as those described with reference to FIGS. 2 to 17, but with sheets and an armature which here are also different.

To simplify the description, the same numerical references were therefore used except for the sheets and the armature for which similar references are used, but adding 400.

In particular, FIGS. 19 and 20 show the electromagnetic braking device 405 in a brake release configuration and in a braking configuration, respectively.

In this device, the bearing portions 482 and the connecting portions 483 are not formed protruding from the main portion 481, but in the main portion 481 via cutouts formed therein.

In other words, the bearing portions 482 and the connecting portions 483 are in the bulk of the main portions 481.

Here each main portion 481 comprises a cutout (not shown) defining a bearing portion 482 and a connecting portion 483 attaching the bearing portion 482 to the main portion 481. The bearing portion 482 is located toward an outer edge of the main portion 481.

The bearing portion 482 is provided with a through hole 485.

Each thinner portion 33 of the spacer 30 is received in a hole 27 of the body 10 and passes through the holes 485 passing through the sheets 416, while the section of the main portion 32 has dimensions greater than those of the through hole 385.

Thus, the shoulder 34 of the spacer 30 here bears against the bearing portion 482 of one of the sheets 416, namely the sheet furthest from the body 10 so as to keep the support portions 482 fixed relative to the body 10.

The armature 414 is provided with guide notches 438 which are each configured such that the main portion 32 of the spacers 30 may pass through them.

The tapped holes of the support 6 are aligned with the guide notches 438 and the holes in the body 10 in order to receive the assembly screws 17.

When the electromagnetic braking device 405 is in its brake release configuration, as shown in FIG. 19, the main portions 481 are compressed between the armature 414 and the body 10 while the bearing portions 482 are compressed between the spacer 30 and the body 10.

When the electromagnetic braking device 405 is in its braking configuration, as shown in FIG. 20, each block formed by the bearing portions 482 is held in contact between the body 10 and the associated spacer 30. The main portion 481 of each sheet 416, which is no longer under the action of the electromagnetic actuating member, is pushed by the mechanical actuating member (not shown) toward the friction disk 15 and is moved independently of the bearing portion 482 by deforming the connecting portion 483.

Of course, the device may comprise more or fewer bearing portions, which may be arranged differently around the main portion.

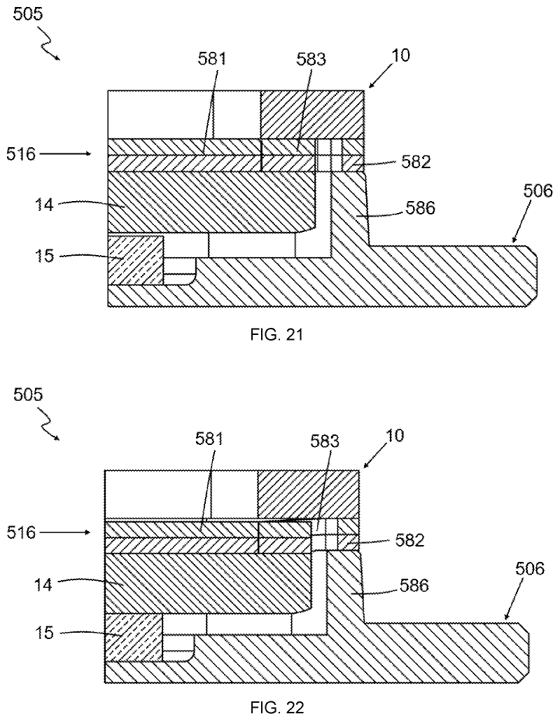

FIGS. 21 and 22 show an electromagnetic braking device according to a sixth embodiment, of the same type as the one described with reference to FIGS. 1 to 20, but with different sheets and support.

To simplify the description, the same numerical references were therefore used except for the sheets and the support for which similar references were used but adding 500.

In particular, FIGS. 21 and 22 show the electromagnetic braking device 505 in a brake release configuration and in a braking configuration, respectively.

In this device, each sheet 516 comprises a bearing member 582 extending around the main portion 581 and forming the bearing portion. In particular, the bearing member 582 forms a peripheral hoop arranged at a distance from an outer edge of the main portion 581. The bearing member 582 is attached to the main portion 581 by a connecting portion 583. The bearing member 582 can also serve as a sealing member.

The support 506 comprises a bearing rim 586 which forms the connecting member and protrudes in the direction of the body 10. The rim 586 comprises a free end which bears against the bearing member 582 of one of the sheets 516. Thus, a sealing function can also be ensured.

The support members 582 bear against one another and for example form a block extending at the periphery of the sheets 516. This arrangement can in particular make it possible to produce a sealed interface between an internal space, delimited by the body 10, the support 506 and the support members 582 and the exterior of the device 505.

In this embodiment, the electromagnetic braking device 505 has no spacer. The rim 586 is thus configured to maintain a predetermined distance between the body 10 and the support 506. The rim 586 is for example complementary in shape to the bearing member 582, which for example has a circular shape.

Variants not shown are described below.

The device may further comprise a plurality of friction disks, with an intermediate flange mounted so as to be movable in translation along the central axis and which is provided between the friction disks.

The device can also comprise a plurality of armatures mounted so as to be movable in translation along the central axis but fixed in rotation.

The body may comprise more than two distinct parts. The sheets and/or the armature may also comprise two or more distinct parts.

Other body, armature, sheet and electric coil sections can be envisaged, for example an oval, parallelepipedal or triangular shape.

When the device comprises a plurality of coils, these coils can be energized independently of one another, or by a set of at least two coils. For example, the coils arranged in a part of a body can be energized independently of the coils arranged in another part of the body.

The coil or coils and the housing(s) may be circular, oval, parallelepipedal, triangular or even bean-shaped.

The compression springs can be distributed in a central regions located between the inner peripheral edge and the outer peripheral edge.

The body may have only one series of blind holes receiving springs, arranged either along an outer edge, or along an inner edge, or in a central region located between the outer edge and the inner edge.

The body can be secured to a flange in the form of a plate, when the electromagnetic braking device is not in direct proximity to a casing, in order to block the friction disk between the armature and the flange.

The assembly screws for mechanically attaching the body to the casing or to a flange can be replaced by bolts.

The device may have no position sensor of the intermediate part.

The device may be provided with an O-ring housed in a groove of the inner face of the body, in particular to further attenuate the noise.

The body of the device may have no central opening. The body may comprise an opening which is not a through-opening, for example opening only onto the inner face or the outer face.

The device may be provided with one or more magnetic shims housed between the inner face of the body and the adjacent first metal sheet, and/or between the magnetic metal sheets or between the armature and the adjacent sheet, in particular to further attenuate the noise or improve the response times of the device.

By virtue of the invention, a simple and efficient electromagnetic braking device can be provided, allowing faster dissipation of the magnetic flux in the armature. Thus, it is possible to reduce the time to change over from a brake release configuration to a braking configuration in comparison with a similar device without magnetic metal sheets.

The magnetic metal sheets allow repeated use of the device without permanent deformation or premature wear due to their elastic properties.

Although, in the above description, the particular aspects of the invention, in particular the implementation of the mobility system, have been described in the context of an elevator, the latter could be implemented in other configurations, in particular with other types of mobility systems.

It is recalled more generally that the invention is not limited to the examples described and shown.

1. An electromagnetic braking device which is configured to block a rotary shaft (7), comprising:
a friction disk (15) which is mounted so as to be movable in translation and in rotation and configured to be secured to the rotary shaft (7);
an outer part (10, 114, 214) and an intermediate part (14, 110, 210, 414) which is mounted so as to be movable in translation between the friction disk (15) and the outer part (10, 114, 214), at least one of the outer part (10, 114, 214) or the intermediate part (14, 110, 210, 414) being magnetic;
at least one electromagnetic actuating member (22, 222) and at least one mechanical actuating member (24, 26, 224, 226) which are housed in the other of the outer part (10, 114, 214) or the intermediate part (14, 110, 210, 414), the intermediate part (14, 110, 210, 414) being configured to move in a first direction, referred to as braking toward the friction disk (15), when it is under the action of the at least one mechanical actuating member (24, 26, 224, 226), and in a second direction opposite to the first direction toward the outer part (10, 114, 214) when the intermediate part (14, 110, 210, 414) is under the action of the at least one electromagnetic actuating member (22, 222); and,
the electromagnetic braking device (5, 105, 205, 305, 405, 505) being characterized in that it further comprises a plurality of magnetic sheets (16, 216, 316, 416, 516) which are independent of one another and movable in translation between the intermediate part (14, 110, 210, 414) and the outer part (10, 114, 214) when they are under the action of the at least one mechanical actuating member (24, 26, 224, 226) and/or under the action of the at least one electromagnetic actuating member (22, 222).

2. The electromagnetic braking device according to claim 1, characterized in that the outer part is formed by a magnetic body (10), respectively a magnetic armature (114, 214), and the intermediate part is formed by a magnetic armature (14, 414), respectively a magnetic body (110, 210).

3. The electromagnetic braking device according to claim 2, characterized in that the at least one electromagnetic actuating member (22, 222) and the at least one mechanical actuating member (24, 26, 224, 226) are housed in the body (10, 110, 210) and the sheets (16, 216, 316, 416, 516) are located against the armature (14, 114, 214, 414) under the action of the at least one mechanical actuating member (24, 26, 224, 226).

4. The braking device according to any claim 1, characterized in that it is configured so that, in a braking configuration, the sheets (16, 216, 316, 416, 516) are pushed by the at least one mechanical actuating member (24, 26, 224, 226) from the outer part (10), respectively the intermediate part (110, 210), toward the intermediate part (14, 414), respectively the outer part (114, 214), and, in a brake release configuration, the sheets (16, 216, 316, 416, 516) are at least partially moved under the action of the at least one electromagnetic actuating member (22, 222) from the intermediate part (14, 414), respectively the outer part (114, 214), toward the outer part (10), respectively the intermediate part (110, 210), with the sheets (16, 216, 316, 416, 516) which are successively deformed under the simultaneous action of the at least one mechanical actuating member (24, 26, 224, 226).

5. The braking device according to claim 1, characterized in that the at least one mechanical actuating member (24, 26, 224, 226) is configured to bias inner and/or outer peripheral regions (62, 64) of the sheets (16, 216, 316, 416, 516), while the electromagnetic actuating member (22, 222) is configured to generate a magnetic flux circulating in the sheets (16, 216, 316, 416, 516), the body (10, 110, 210) and the armature (14, 114, 214, 414).

6. The braking device according to claim 1, characterized in that the ratio between a thickness (Ea) of the intermediate part (14, 414), respectively of the outer part (114, 214), and a thickness (Eft) of the sheets (16, 216, 316, 416, 516) bearing against one another is between approximately 0.2 and approximately 30.

7. The braking device according to claim 1, characterized in that it comprises between approximately 2 and approximately 30 sheets (16, 216, 316, 416, 516).

8. The braking device according to claim 1, characterized in that each sheet (16, 216, 316, 416, 516) has a thickness (Ef) of between 0.3 mm and approximately 5 mm and/or each sheet (16, 216, 316, 416, 516) has substantially the same thickness (Ef).

9. The braking device according claim 1, characterized in that the outer part (10) or the intermediate part (110, 210) has an inner face (11, 211) and comprises at least one blind hole (23, 25, 223, 225) opening onto said inner face (11, 211), the at least one mechanical actuating member (24, 26, 224, 226) being a compression spring which is partially housed in said blind hole (23, 25, 223, 225) and projects from said inner face (11, 211) until it comes into contact with one of the sheets (16, 216, 316, 416, 516) which is directly facing said inner face (11, 211).

10. The braking device according to claim 9, characterized in that it comprises a plurality of compression springs (24, 26, 224, 226) which are distributed along an outer peripheral edge (74) and/or an inner peripheral edge (72) of said inner face (11).

11. The braking device according to claim 1, characterized in that the outer part (10) or the intermediate part (110, 210) has an inner face (11) and comprises a housing (21, 221) which is provided in said inner face (11, 211), the electromagnetic actuating member (22, 222) comprising an electric coil which is housed in said housing (21, 221) and configured to generate a magnetic flux circulating in said sheets (16, 216, 316, 416, 516) and in said outer part (10, 114, 214) and in the intermediate part (14, 110, 210, 414) when said electric coil is supplied with electric current.

12. The braking device according to claim 1, characterized in that the outer part (10, 114, 214) is configured to be mechanically secured to a support (6, 506), the friction disk (15) being located axially between the intermediate part (14, 110, 210, 414) and said support (6, 506).

13. The braking device according to claim 12, characterized in that it comprises at least one assembly member (17) having a first end which is mechanically secured to said outer part (10, 114, 214) and a second end which is opposite to said first end and is mechanically secured on said support (6, 506) such that said friction disk (15), said intermediate part (14, 110, 210, 414) and said sheets (16, 216, 316, 416, 516) are located between said outer part (10, 114, 214) and said support (6, 506).

14. The braking device according to claim 13, characterized in that it comprises at least one connecting member (30, 230) having a main portion (32), a first end of which is configured to bear against said support (6) and a second end, which is opposite the first end, is configured to bear against said outer part (10, 114, 214), the at least one connecting member (30, 230) comprising a through hole (31) which is configured such that said assembly member (17) may pass through it.

15. The braking device according to claim 14, characterized in that it comprises a plurality of connecting members (30, 230) which are distributed along an outer peripheral edge (74) of said outer part (10, 114, 214).

16. The electromagnetic braking device according to claim 1, characterized in that it comprises at least one connecting member (30, 230, 586) which is configured to maintain a predetermined distance between the outer part (10, 214) and a support (6, 506) which is intended to clamp, together with the intermediate part (14, 210, 414), the friction disk (15), and in that each sheet (316, 416, 516) comprises a main portion (381, 481, 581), a bearing portion (382, 482, 582) and a connecting portion (383, 483, 583) attaching the bearing portion (382, 482, 582) to the main portion (381, 481, 581) of the sheet (316, 416, 516), the connecting member (30, 230, 586) being supported against the bearing portion (382, 482, 582) of one of the sheets (316, 416, 516) such that the bearing portions (382, 482, 582) of all the sheets bear against one another and are placed between and held in contact between the connecting member (30, 230, 586) and the outer part (10, 214), and each connecting portion (383, 483, 583) being configured to be deformed when the main portion (381, 481, 581) of the associated sheet (316, 416, 516) is deformed under the action of the at least one mechanical actuating member (24, 26, 224, 226) and/or the at least one electromagnetic actuating member (22, 222).

17. The electromagnetic braking device according to claim 16, characterized in that each sheet (316, 416) comprises bearing portions (382, 482) which are separate and at a distance from one another, each bearing portion (382, 482) being arranged in an external projection from the main portion (381, 481) or in the main portion (381, 481), and the at least one connecting member (30, 230) is formed by a spacer.

18. The electromagnetic braking device according to claim 16, characterized in that each sheet comprises a bearing member (582) extending around the main portion (581) of the associated sheet (516) and forming the bearing portion (582), the support (506) comprising a bearing rim (586) forming the connecting member (583).

19. The braking device according to claim 14, characterized in that the outer part (10, 114) comprises at least one through hole (27) having a first end opening onto a face turned toward said intermediate part (14, 110), the at least one through hole (27) being widened on the side of its first end and the at least one connecting member (30) comprising a thinner end portion (33) which is configured to be received in the at least one through hole (27) on the side of its first end.

20. A mobility system, for example of the elevator or forklift type, comprising an electromagnetic braking device according to claim 1 and a rotary shaft (7) which is integral with a friction disk (15) of the electromagnetic braking device (5, 105, 205, 305, 405, 505), with the rotary shaft (7) which is blocked in rotation when the intermediate part (14, 110, 210, 414) has been moved in the first direction, referred to as the braking direction, and when it bears against the friction disk (15), and with the rotary shaft (7) which is free in rotation when the intermediate part (14, 110, 210, 414) has been moved in the second direction opposite to the first direction and when it is away from the friction disk (15).
